(19) United States
(12) Patent Application Publication
(10) Pub. No.: US 2013/0321696 A1
(43) Pub. Date: Dec. 5, 2013

(54) Camera Integrated with Connector for Vehicle and Method of Manufacturing Thereof

(71) Applicant: A&P CREBIZ CO., LTD, Incheon (KR)

(72) Inventor: Bang Hee Bae, Seoul (KR)

(73) Assignee: A&P Crebiz Co., Ltd, Incheon (KR)

(21) Appl. No.: 13/677,756

(22) Filed: Nov. 15, 2012

(30) Foreign Application Priority Data
Jun. 1, 2012 (KR) 10-2012-0059442

(51) Int. Cl. H04N 5/225

(52) U.S. Cl. CPC H04N 5/2252
USPC 348/372; 348/373; 29/527.1

(57) ABSTRACT

The present invention relates to a camera integrated with a connector for a vehicle and a method of manufacturing thereof, and the camera integrated with a connector for a vehicle includes: a housing; and a camera module accommodated inside the housing, in which a connector unit is formed in one piece at a certain position on one side of the housing, and a protection cover for protecting the camera module from being damaged by injection pressure and injection temperature generated when the housing is molded by injection is combined outside the camera module. The method of manufacturing camera integrated with a connector for a vehicle includes: a camera module assembly step, a camera module inserting step, an injection molding step and an extraction step.

### CROSS-REFERENCE TO RELATED APPLICATION

This application is based on and claims priority from Korean Patent Application No. 10-2012-0059442, filed on Jun. 1, 2012 in the Korean Intellectual Property Office, the disclosure of which is incorporated herein in its entirety by reference.

### BACKGROUND OF THE INVENTION

1. Field of the Invention

The present invention relates to a camera integrated with a connector for a vehicle and a method of manufacturing thereof, and more specifically, to a camera integrated with a connector for a vehicle and a method of manufacturing thereof, which can prevent substrates in a camera module from being damaged by injection pressure and injection temperature generated when a housing is formed in one piece outside the camera module through injection molding.

2. Background of the Related Art

Generally, when a person drives a vehicle, a situation in the rear, as well as in the front, is very important. Particularly, when the driver changes lanes or drives backward, the driver should change lanes or drive backward after clearly recognizing the situations in the rear and on the back left and back right sides in order to prevent an accident.

As described, when the driver changes lanes or drives backward while driving along a lane, the driver puts changing lanes or driving backward into action when it is determined that the vehicle is in a safe state by keeping a sufficient distance from a vehicle following behind or there is no obstacle in the rear after confirming situations in the rear and on the back left and back right sides through side mirrors protruded on both sides of the body or a room mirror mounted inside the vehicle.

However, if the driver is a beginner, an accident may occur since the driver is not skilled in determining a situation in the rear through the side mirrors or the room mirror while driving, and it is very difficult to clearly recognize an obstacle in the rear.

In order to solve this problem, recently, cameras are installed on the front or back side of a vehicle to photograph and display traffic information and subjects in the front and rear through a display device provided inside the vehicle, and thus the driver may grasp situations in the blind spots in the front and rear, particularly in the rear, and this is helpful for safe driving.

Referring to FIGS. 1 and 2, a conventional camera 10 for a vehicle includes a camera module 20 accommodated inside a housing 12, and a connector unit 14 is formed in one piece at a certain position on one side of the housing 12.

Here, the camera module 20 includes a lens holder 22 having a lens 22a, and the camera module also includes an image sensor substrate 24, a dummy 26, a power substrate 28, a sealing cover 30 and a terminal 32 sequentially placed inside the lens holder 22.

However, the conventional camera 10 for a vehicle having a structure described above has a problem in that the sealing cover 30 is deformed or damaged by injection pressure and injection temperature generated when the housing 12 is molded by injection outside the camera module 20, and thus the image sensor substrate 24 and the power substrate 28 placed inside the lens holder 22 are damaged.

### SUMMARY OF THE INVENTION

Accordingly, the present invention has been made in view of the above-mentioned problems occurring in the prior art, and it is an object of the present invention to provide a camera integrated with a connector for a vehicle and a method of manufacturing thereof, which can prevent a camera module from being damaged by injection pressure and injection temperature generated when a housing is formed outside the camera module through injection molding.

To accomplish the above object, according to an aspect of the present invention, there is provided a camera integrated with a connector for a vehicle, the camera comprising: a housing; and a camera module accommodated inside the housing, in which a connector unit is formed in one piece at a certain position on one side of the housing, and a protection cover for protecting the camera module from being damaged by injection pressure and injection temperature generated when the housing is molded by injection is combined outside the camera module.

The housing is formed outside the camera module in one piece through injection molding.

The camera module includes a lens holder having a lens, an image sensor substrate positioned inside the lens holder to collect external light entering through the lens, a power substrate combined on one side of the image sensor substrate, and a terminal cover combined on one side of the power substrate and connected to a circuit element of the power substrate so as to supply power.

According to another aspect of the present invention, there is provided a method of manufacturing a camera integrated with a connector for a vehicle, the method comprising: a camera module assembly step of assembling a camera module including a lens holder having a lens, an image sensor substrate, a power substrate, a terminal cover and a protection cover; a camera module inserting step of inserting the camera module assembled in the camera module assembly step into an injection molder configured of upper and lower casts; an injection molding step of providing synthetic resin of a liquid state so that the housing is formed outside the camera module; and an extraction step of opening the injection molder after cooling down the synthetic resin and extracting the camera for a vehicle from the injection molder, after performing the injection molding step, in which the camera module assembly step includes a protection cover combining step of combining the protection cover outside the camera module, the protection cover for preventing the camera module from being damaged by injection pressure and injection temperature generated in the injection molding step.

### BRIEF DESCRIPTION OF THE DRAWINGS

FIG. 1 is an exploded perspective view showing a conventional camera for a vehicle.

FIG. 2 is a cross-sectional view showing a conventional camera for a vehicle.

FIG. 3 is a perspective view showing a camera integrated with a connector for a vehicle according to an embodiment of the present invention.

FIG. 4 is an exploded perspective view showing a camera integrated with a connector for a vehicle according to an embodiment of the present invention.

FIG. 5 is a cross-sectional view showing a camera integrated with a connector for a vehicle according to an embodiment of the present invention.

FIG. 6 is a flowchart illustrating a method of manufacturing a camera integrated with a connector for a vehicle according to an embodiment of the present invention.

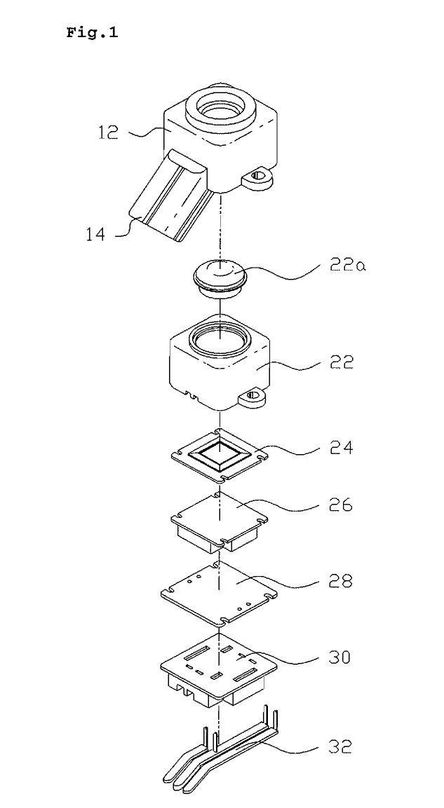

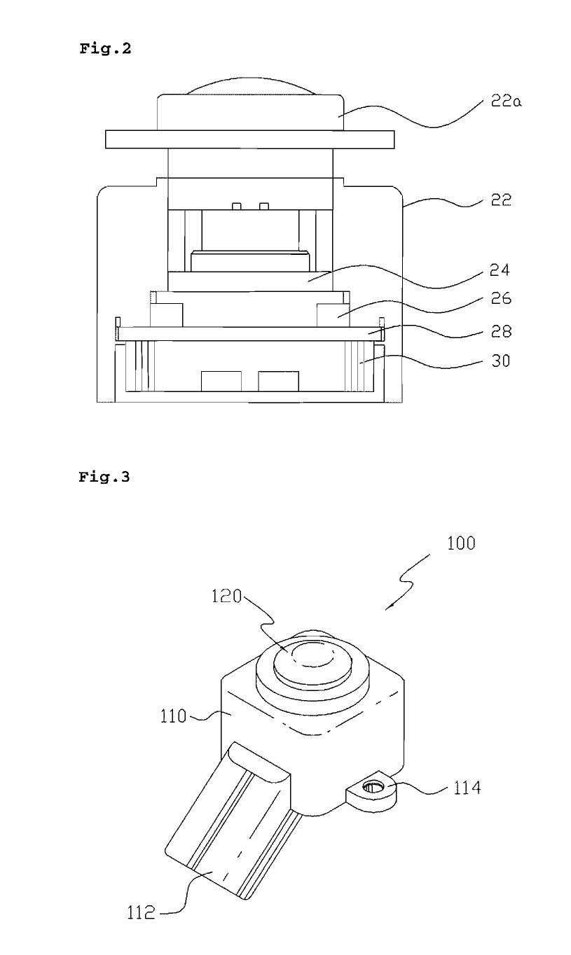

DESCRIPTION OF SYMBOLS

| | |
|---|---|
| 100: Camera integrated with connector for vehicle | |
| 110: Housing | 112: Connector unit |
| 114: Connection unit | 120: Camera module |
| 122: Lens holder | 122a: Lens |
| 124: Image sensor substrate | 126: Power substrate |
| 128: Terminal cover | 128a: Body |
| 128b: Terminal | 130: Protection cover |
| S10: Camera module assembly step | |
| S20: Camera module inserting step | |
| S30: Injection molding step | |
| S40: Extraction step | |
| S50: Protection cover combining step | |

### DETAILED DESCRIPTION OF THE PREFERRED EMBODIMENT

Hereinafter, a preferred embodiment of the present invention will be described in further detail with reference to the attached drawings. In the steps, thickness of the lines and sizes of the constitutional components shown in the drawings can be exaggerated for clarity and convenience of the description.

The terms used herein are defined in consideration of functions in the present invention, and therefore, the terms will be construed as concepts corresponding to the spirit of the present invention and conventional meanings.

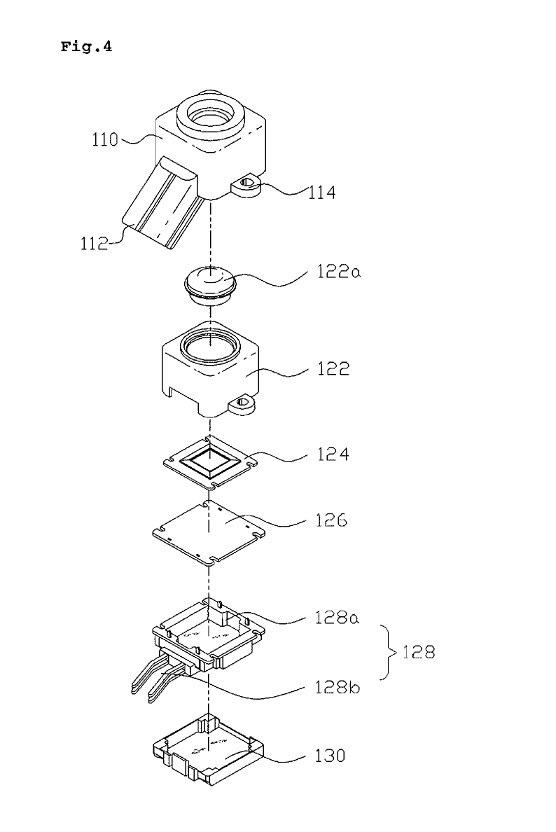

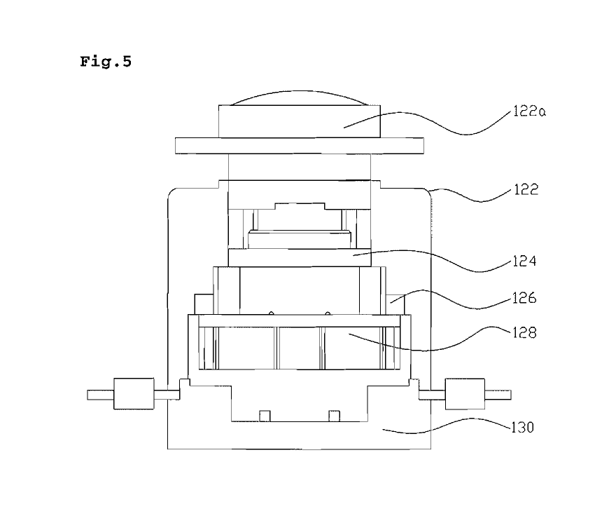

FIG. 3 is a perspective view showing a camera integrated with a connector for a vehicle according to an embodiment of the present invention, FIG. 4 is an exploded perspective view showing a camera integrated with a connector for a vehicle according to an embodiment of the present invention, and FIG. 5 is a cross-sectional view showing a camera integrated with a connector for a vehicle according to an embodiment of the present invention.

Referring to FIGS. 3 to 5, the camera integrated with a connector for a vehicle according to an embodiment of the present invention includes a housing 110, a camera module 120, a connector unit 112 and a protection cover 130.

The housing 110 is formed in a rectangular or circular shape, and the camera module 120 described below is positioned inside the housing.

The housing 110 is formed in one piece outside the camera module 120 through injection molding so that moisture or foreign materials may not flow into the camera module 120.

In addition, the connector unit 112 is formed at a certain position on one side of the housing 110 so that a wiring cable (not shown) can be connected.

One end of a terminal 128b described below is positioned at the connector unit 112, and the wiring cable and the terminal 128b are firmly combined by combining the wiring cable to the terminal 128b, and thus a contact failure phenomenon can be prevented.

In addition, a pair of connection units 114 is symmetrically formed at certain positions on both sides of the housing 110, and the connection units 114 combine the housing 110 with the vehicle.

The camera module 120 includes a lens holder 122 having a lens 122, an image sensor substrate 124 positioned inside the lens holder 122 to collect external light entering through the lens 122a, a power substrate 126 combined on one side of the image sensor substrate 124, and a terminal cover 128 combined on one side of the power substrate 126.

Here, the terminal cover 128 includes a body 128a combined on one side of the power substrate 126 and the terminal 128b combined with the body 128a to supply power to the power substrate 126.

At this point, one end of the terminal 128b is positioned inside the connector unit 112, combined with the wiring cable and supplied with power.

The protection cover 130 is combined on the bottom of the lens holder 122 to protect the camera module 120 from being damaged by injection pressure and injection temperature generated when the housing 110 is molded by injection outside the camera module 120.

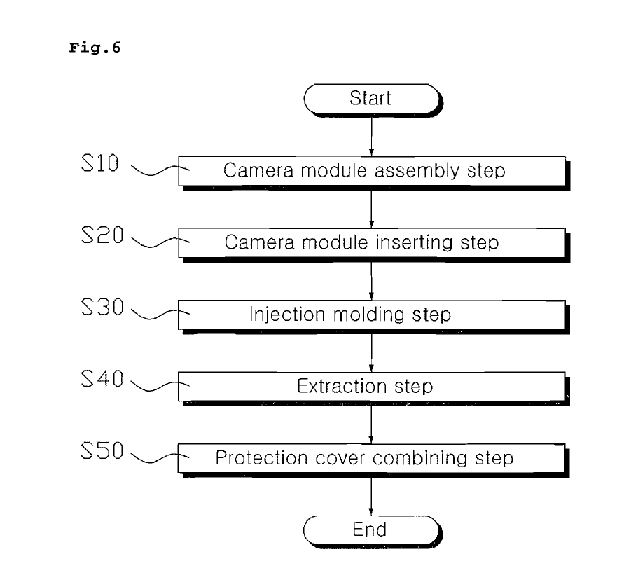

FIG. 6 is a flowchart illustrating a method of manufacturing a camera integrated with a connector for a vehicle according to an embodiment of the present invention.

Referring to FIG. 6, the method of manufacturing a camera integrated with a connector for a vehicle according to an embodiment of the present invention includes a camera module assembly step S10, a camera module inserting step S20, an injection molding step S30, an extraction step S40 and a protection cover combining step S50.

The camera module assembly step S10 assembles the camera module 120 including the lens holder 122 having the lens 122, the image sensor substrate 124, the power substrate 126 and the terminal cover 128.

Here, the camera module assembly step S10 preferably further includes the protection cover combining step S50 of combining a protection cover outside the camera module 120, i.e., on the bottom of the lens holder 122 included in the camera module 120, in order to prevent the camera module from being damaged by injection pressure and injection temperature generated in the injection molding step described below.

The camera module inserting step S20 inserts the camera module 120 assembled in the camera module assembly step S10 into an injection molder (not shown) configured of upper and lower casts (not shown).

The injection molding step S30 provides synthetic resin of a liquid state so that the housing 110 can be formed outside the camera module 120 inserted in the injection molder.

After performing the injection molding step S30, the extraction step S40 opens the injection molder after cooling down the synthetic resin and extracts the camera 100 integrated with a connector for a vehicle from the injection molder.

Therefore, according to the camera integrated with a connector for a vehicle and the method of manufacturing thereof, the camera module can be prevented from being damaged by injection pressure and injection temperature generated when the housing is formed by injection outside the camera module.

According to an embodiment of the present invention, it is effective in that the camera module can be prevented from being damaged by injection pressure and injection temperature generated when the housing is formed by injection outside the camera module.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A camera integrated with a connector for a vehicle, the camera comprising:
a housing; and
a camera module accommodated inside the housing, wherein
a connector unit is formed in one piece at a certain position on one side of the housing, and a protection cover for protecting the camera module from being damaged by injection pressure and injection temperature generated when the housing is molded by injection is combined outside the camera module.

2. The camera according to claim 1, wherein the housing is formed outside the camera module in one piece through injection molding.

3. The camera according to claim 2, wherein the camera module includes a lens holder having a lens, an image sensor substrate positioned inside the lens holder to collect external light entering through the lens, a power substrate combined on one side of the image sensor substrate, and a terminal cover combined on one side of the power substrate and connected to a circuit element of the power substrate so as to supply power.

4. A method of manufacturing a camera integrated with a connector for a vehicle, the method comprising:
a camera module assembly step of assembling a camera module including a lens holder having a lens, an image sensor substrate, a power substrate, a terminal cover and a protection cover;
a camera module inserting step of inserting the camera module assembled in the camera module assembly step into an injection molder configured of upper and lower casts;
an injection molding step of providing synthetic resin of a liquid state so that the housing is formed outside the camera module; and
an extraction step of opening the injection molder after cooling down the synthetic resin and extracting the camera for a vehicle from the injection molder, after performing the injection molding step, wherein the camera module assembly step includes
a protection cover combining step of combining the protection cover outside the camera module, the protection cover for preventing the camera module from being damaged by injection pressure and injection temperature generated in the injection molding step.
